(19) United States
(12) Patent Application Publication
(10) Pub. No.: US 2007/0083412 A1
(43) Pub. Date: Apr. 12, 2007

(54) Budgeting requirements model generator

(76) Inventors: Elizabeth A. Sternaman, Springfield, VA (US); Janice Buxbaum, Alexandria, VA (US)

Correspondence Address: ROBERTS, MARDULA & WERTHEIM, LLC, 11800 SUNRISE VALLEY DRIVE, SUITE 1000, RESTON, VA, 20191, US

(21) Appl. No.: 11/233,547

(22) Filed: Sep. 23, 2005

(51) Int. Cl. G06Q 40/00; G05B 19/418

(52) U.S. Cl. 705/8; 705/35

(57) ABSTRACT

A budget requirements model generator (BRMG) that determines budgeting requirements for a project across funding categories. The BRMG is organized in a hierarchical structure. The hierarchical structure is imposed on a budgetary process thereby providing uniform budgeting tools at all levels of an organization. A baseline budget is determined at a task level reflecting the costs of completing the task without regard to resource limitations. A constrained model run reflects the reality of limited resources. Constraints may be imposed on costs to produce a budgetary model that reflects a resulting readiness. Alternatively, constraints may be imposed on readiness to produce a resulting cost. Because all systems are analyzed using the same tools, decision makers can compare constrained budgetary models for all systems to determine objectively how budgetary allocations within an organization should be made.

### GOVERNMENT LICENSE RIGHTS

The U.S. Government has a paid-up license in this invention and the right in limited circumstances to require the patent owner to license others on reasonable terms as provided for by the terms of Contract No. N00174-01-D-0010 awarded by the U.S. Navy, Indian Head Division, Naval Surface Warfare Center.

### SUMMARY

Government agencies and business organizations are fueled by monetary resources. The federal budget for fiscal year 2005 is $2.1 trillion dollars, plus or minus a few hundred billion dollars. Defense expenditures alone are expected to top $558 billion dollars. Within the defense budget, operation and maintenance is allocate $154B, procurement $81B, and research and development $68B. General Motors reported costs and expenses for 2004 of $192B. The State of California's budget for 2005-2006 is approximately $85B. Managing these expenditures is not only complicated by the magnitude of the sums involved but in the difficulties in assessing what programs to fund on an objective basis.

Historically, budgetary planning has been performed within organizations without a common analytical reference. Given this lack of a standardized model, budgetary “requirements” within organizational units are difficult to compare. Additionally, the process creates incentives for dysfunctional behavior, such as year-end spending sprees to avoid budget cuts in the next cycle. Thus, budgetary priorities are not established through objective analysis, largely because the tools to provide an objective analysis are not available. In long lead procurement environments, such as, but not limited to, large corporation entity and governmental budgeting, the consequences of poor decision making at the planning stage may adversely affect the organization's ability to provide services and operational resources at a later time.

A typical budgetary process within an organization requires an organizational unit to determine what financial resources are required for that unit to achieve its assigned goals. The goal is parsed into tasks that must be completed in order for the goal to be achieved. The cost of completing these tasks is determined and aggregated. The problem in most budgetary processes occurs when the aggregated costs of the budgetary unit's tasks exceed the funds allocated or available for that budgetary unit. A decision maker must decide which tasks of the budgetary will not be funded or fully funded, or, alternatively, whether to allocate more resources to the budgetary unit. As most organizations have only finite resources, the allocation of additional resources to one budgetary unit usually means reducing the allocation of resources to another budgetary unit. What is currently missing in this process is a way of measuring the consequences of such decisions in objective terms that reflect the impact on the ability of a budgetary unit to achieve its goals and on the ability of the organization as a whole to achieve its objectives.

The success or failure of a procurement process is often described in terms of “readiness.” In military programs, readiness may be described by the ability to deploy troops, the ability to support multiple operations, or the ability to provide a defense against an offensive weapon, to name a few. The concept of “readiness” is not limited to military programs. Disaster relief agency procurement may be described in readiness terms. Corporations that provide goods and services may also use this concept to allocate resources during a financial planning process. However, budgetary modeling tools currently available do not incorporate a readiness or similar metric in a uniform and meaningful way that allows decision makers to understand the consequences of financial decisions at all levels within an organization.

What is needed is a financial planning model that combines quantitative and qualitative measures of readiness across funding categories that optimizes the allocation of resources based on assigned priority and readiness impact in specific elements in the funding categories.

An embodiment of the present invention comprises a budget requirements model generator (BRMG) that determines budgeting requirements for a project across funding categories. In this embodiment, the BRMG is organized in a hierarchical structure. The hierarchical structure is imposed on a budgetary process thereby providing uniform budgeting tools at all levels of an organization.

At the base level of this structure are systems. A system comprises budget elements, such as, without limitation, resource acquisition, print marketing, multi-media marketing, program management, configuration management, resource distribution, and technical publications. Each system is associated with at least one funding category. By way of illustration and not as a limitation, funding categories may be system support, system maintenance, system quality evaluation, advertising, and customer support. A funding category comprises funding elements which, combined, determine the system's total budget requirements. Funding elements may be specified in a category for a particular system down to the individual task and subtask level. A funding element may also be determined for a task to be performed at a particular location, in a particular timeframe, with a specified priority.

Additionally, a funding category is associated with a funding profile. A funding profile comprises a set of tasks and funding elements related to a system. Funding profiles build upon tasks and funding elements and are the basis of model runs, such as a requirements run, which yields the funding needed to maintain full readiness for a particular weapons system, or a constrained run, which shows the reduction in available weapons if the budget is cut. Funding profiles comprise the functions allowing a user to set up a grouping of funding elements. Custom and execution funding profiles can be saved and edited. Different types of model runs can be performed on one funding profile.

Each funding category is associated with a mission requirement. A mission requirement is defined as a level of funding expected to provide 100% readiness for that funding category. As used herein, “readiness” is a measure of the state of having been made ready or prepared for use or action. The BRMG combines quantitative and qualitative measures of readiness across the funding categories and interactively optimizes the allocation of budgetary resources based on assigned priority and readiness impact in specific elements in the funding categories.

For each funding category, there are a set of tasks taken from a corporate level work breakdown structure. The purpose of using these common tasks is to enable a common ground for high level analysis and to provide a disciplined approach to describing cost requirements. Each task within a system has an associated readiness impact measure (a unit-less readiness measure ranging from 0 to 1.0) defined as reduction in readiness from 1.0 if the task were not performed. A task partially unfunded will reduce readiness relative to its funding deficit.

A component is comprised of designated systems. A program provides management and funding of a system. A component may be supported by one or more programs. Systems and programs are associated with resource levels. Resource levels are combined to make up a funding account.

In an embodiment of the present invention, the BRMG produces model runs at a system level, multiple system level, and at an entire funding account level by aggregating systems. By way of illustration and not as a limitation, an “unconstrained” model run will produce budgeting requirements assuming 100 percent readiness to determine a baseline budget. This budget reflects the costs without regard to resource limitations. A constrained model run reflects the reality of limited resources. Constraints may be imposed on costs to produce a budgetary model that reflects a resulting readiness. Alternatively, constraints may be imposed on readiness to produce a resulting cost. Because all systems are analyzed using the same tools, decision makers can compare constrained budgetary models for all systems to determine objectively how budgetary allocations within an organization should be made. In this embodiment of the present invention, budgeting requirements are determined based on prioritizing funding elements. A funding profiles module produces a funding profile that feeds each model run. In an embodiment of the present invention, a funding profile is selected from a list of approved funding profiles.

It is therefore an aspect of the present invention, to optimize the allocation of budgetary resources and to determine the effect of budgetary decisions on readiness.

It is yet another aspect of the present invention to facilitate informed budgetary decisions by permitting options to be evaluated and trade-off assessments to be made.

It is still another aspect of the present invention to establish a predictable and accountable relationship between resources and output.

It is even another aspect of the present invention, to integrate performance with the budget so as to increase productivity and reduce the cost of readiness.

It is another aspect of the present invention to evaluate the costs of deferred maintenance on readiness.

These and other aspects of the present invention will be apparent after a review of the description and figures that follow.

An embodiment of the present invention provides a method for generating a budgetary model. An available funding is established for a project. The project comprises funding elements each funding element is associated with a priority, a cost of completing the funding element, an FE readiness measure, and a partial funding minimum. The funding elements are ordered according to a descending priority. A determination is made whether a remaining funding for the project is equal to or greater than the cost of completing a particular funding element. The remaining funding is the available funding less amounts allocated for other funding elements. If the remaining funding for the project is equal to or greater than the cost of completing the particular funding element, then a portion of the remaining funding is allocated to the funding element equal to the cost of completing the funding. If the remaining funding for the project is less than the cost of completing the particular funding element, then a determination is made whether a particular FE readiness measure of the particular funding element is greater than other FE readiness measures of the other funding elements having the same priority as the particular FE readiness measure. A determination is also made as to whether the remaining funding for the project exceeds the partial funding minimum of the particular funding element. If the particular FE readiness measure of the particular funding element is greater than the FE readiness measures of the other funding elements having the same priority as the particular funding element and if the remaining funding exceeds the partial funding minimum of the particular funding element, then the remaining funding for the project is allocated to the particular funding element.

If the remaining funding for the project is less than the cost of completing the particular funding element, a determination is made whether the remaining funding for the project exceeds the partial funding minimum of a next funding element having the same priority as the particular funding element. Additionally, a determination is made whether a FE readiness measure of the next funding element is greater than readiness measures the other next funding elements having the same priority as the particular funding element. If the FE readiness measure of the next funding element is greater than the FE readiness measures of the other next funding elements having the same priority as the particular funding element and if the remaining funding exceeds the partial funding minimum of the next funding element, the remaining funding is allocated to the next funding element having the same priority as the particular funding element.

If the remaining funding for the project exceeds the partial funding minimum of the next funding element having the same priority as the particular funding element, a determination is made whether the remaining funding for the project exceeds the partial funding minimum of a later funding element having a lower priority than the particular funding element. Additionally, a determination is made whether a FE readiness measure of the later funding element is greater than readiness measures of other later funding elements having the same lower priority as the later funding element. If the FE readiness measure of the later funding element is greater than the FE readiness measures of the other later funding elements having the same lower priority as the later funding element and if the remaining funding exceeds the partial funding minimum of the later funding element, the remaining funding is allocated to the later funding element having lower priority than the particular funding element.

### DESCRIPTION OF THE DRAWINGS

FIG. 1 illustrates the logical elements of a budgetary system according to an embodiment of the present invention.

FIG. 2 illustrates a funding process according to an exemplary embodiment of the present invention.

### DETAILED DESCRIPTION

The following terms have the meaning ascribed to them:

| | |
|---|---|
| constrained | model run that restricts the number of elements that can be |
| run | funded based on actual funding or readiness to be |
| | achieved; gives a more accurate budget for your systems |
| | from a real-world perspective; cost or performance |
| | constraints can be used |
| cost | actual total cost dollar amount across all systems is |
| constraint | specified, and the model run is based on this hard |
| | constraint |
| funding | description of a task to be funded for a system/subsystem |
| element | at a particular location; includes all information needed to |
| | determine the cost for each funding category |
| funding | a set of data producing optimal first year requirements and |
| profile | constrained model run results; and is used as the master set |
| | of data for all models created in a given fiscal year; |
| | includes system, custom, and shared |
| maintenance | a type of task in BRMG, relating to funding; the physical |
| | act of preventing, determining, and correcting equipment |
| | or software faults; includes all actions taken to retain |
| | system or equipment or product in a useful serviceable |
| | condition or to restore it to usefulness or serviceability; |
| | also includes inspection, fault isolation, testing, and |
| | servicing |
| model run | types include requirements (unconstrained), funded |
| | (constrained), and what-if; checks items such as funding |
| | profiles, task requirements, priorities, maintenance |
| | locations, and weapons systems involved to produce |
| | funding levels needed or readiness levels, given specific |
| | funding |
| Priority: | Priority is expressed as a value that determines the relative |
| | importance of a task. By way of illustration and not as |
| | limitation, a number from 1 to 10 may be used to specify |
| | the priority for a funding element, with 1 being the highest |
| | priority. A priority of “0” may be used to indicate that the |
| | funding element must be funded. |
| QE | quality evaluation a type of task, relating to funding; a |
| | process of ensuring that a system's inventory meets |
| | readiness requirements for reliability, quality, and safety. |
| readiness | indicates the percentage of the impact that a particular |
| allocation | funding element contributes; for example, if the task is |
| | tech pubs, and three need to be done, but one is really |
| | important and the other two are not, the percentage |
| | impacts may be 90, 5, and 5; total readiness allocation for |
| | a task must be 100 percent |
| readiness | constraint on a model run based on the desired level of |
| constraint | readiness, for example, 95 percent |
| readiness | indicates the reduction in readiness from a value of 1.0 |
| impact | caused by not funding a task; in theory, all funding |
| measure | elements will have some readiness impact, even if that |
| | number is near zero |
| readiness | a measure of the overall ability of the system to do the job |
| | it is supposed to do |
| requirements | baseline run; budget for a requirements run is |
| run | unconstrained, and priorities are ignored; assumes 100- |
| | percent funding and 100% readiness for all systems |
| task | a collection of funding elements comprising a high-level |
| | job to be performed, such as completing Technical |
| | Publications |
| WBS | work breakdown structure |
| SS | systems support a type of task in BRMG, relating to |
| | funding; a package of logistics support functions necessary |
| | to maintain the readiness and operational capability of a |
| | system |

An embodiment of the present invention comprises a budget requirements model generator (BRMG) that determines budgeting requirements for a project across funding categories. In this embodiment, the BRMG model is organized in a hierarchical structure.

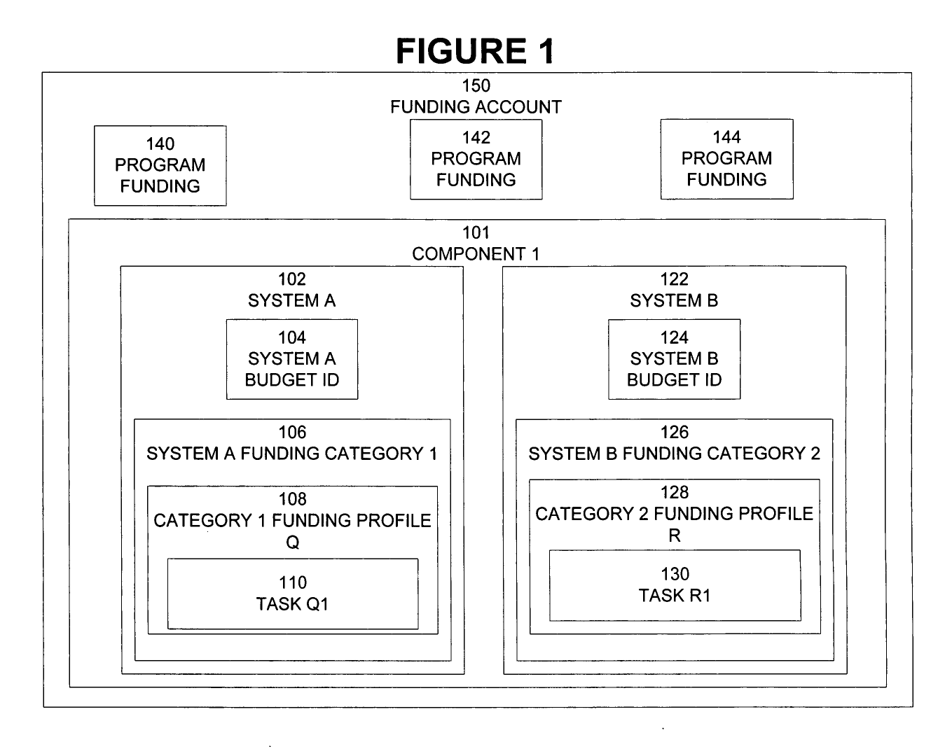

FIG. 1 illustrates the logical elements of a budgetary system according to an embodiment of the present invention. Referring to FIG. 1, at the base level of this structure are system A 102 and system B 122. A unique system support budget comprising budget elements is associated with each system (104 and 124). A system is associated with funding profiles. For ease of illustration and not as a limitation only two funding profiles (system A funding profile 1 106 and system B funding profile 2 126) are illustrated. Additionally, a funding profile is associated with tasks grouped as a funding category. Again, for ease of illustration and not as a limitation, only a single funding category (108 and 128) is illustrated for each funding profile 1 106 and funding profile 2 126. As you go outside the base level, FIG. 1 illustrates that multiple systems can aggregate to a component (101) or aggregate to a program (140, 142, or 144). Multiple programs can further aggregate to a funding account (150).

Referring to FIG. 1, system A funding profile 1 106 comprises funding category Q 108, which further comprises a task Q1 110. System B funding profile 2 126 comprises funding category 128, which further comprises a task R1 130.

Each funding category has 100% readiness defined as the tasks necessary to attain the mission requirement for that funding category. As used herein, “readiness” is a measure of the state of having been made ready or prepared for use or action. The BRMG combines quantitative and qualitative measures of readiness across the funding categories and interactively optimizes the allocation of budgetary resources based on assigned priority and readiness impact in specific elements in the funding categories.

As described above, a funding category is associated with at least one funding profile comprising a set of tasks. In an embodiment of the present invention, each task within a system is associated with a readiness impact measure. Readiness is defined as a measure of the overall ability of the system to do the job it is intended to do. If a system's readiness at 100 percent funding is 1.0, a partially unfunded task will reduce readiness relative to its funding deficit. The readiness measure is the reduction of readiness at a specified level of funding.

To determine optimal resource allocation in a constrained environment, the BRMG employs a unique iterative optimization scheme. This process was developed in order to embrace the notion that knowledgeable managers understand their system, tasks and funding elements best and are best qualified to determine priorities. According to an embodiment of the present invention, the BRMG comprises optimization rules that preclude the funding of a priority 2 task when there are sufficient funds to fund a priority 1 task. An iterative optimizer creates several smaller constraint matrices (one for each priority grouping), rather than one large matrix. Thus, according to this embodiment, funding elements within tasks “compete” only with funding elements of the same priority, and no lesser priority funding element can be funded until all higher priority funding elements have had the opportunity to be funded.

The BRMG is executed one year at a time. When executed in multi-year mode, users have the option to roll unfunded requirements into the next year.

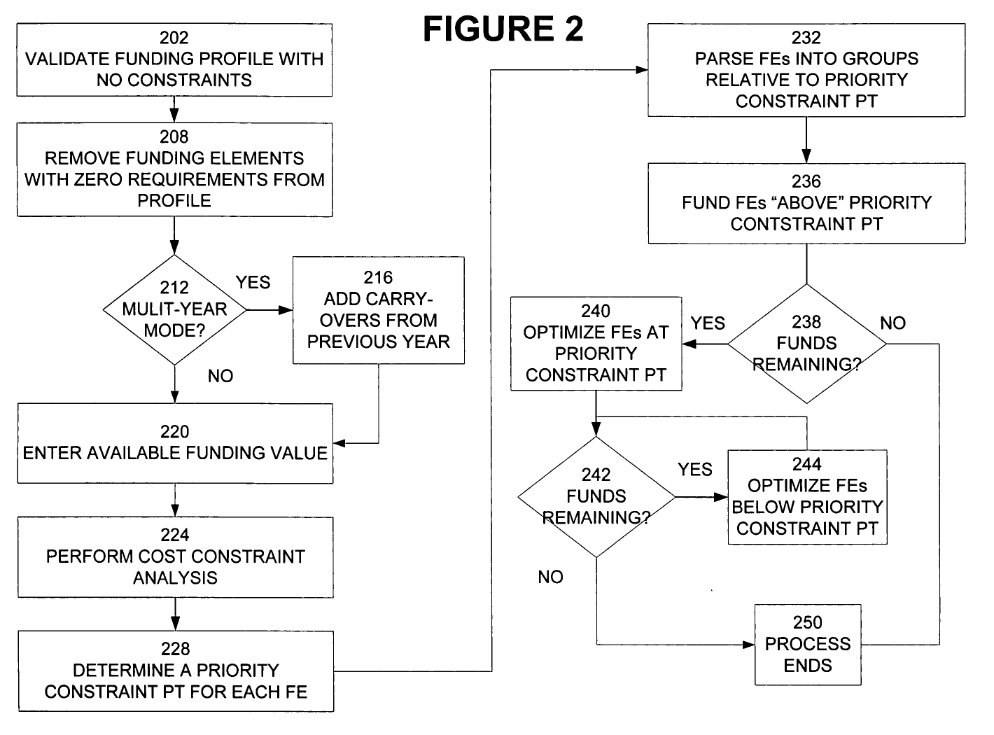

FIG. 2 illustrates a funding process for a system according to an exemplary embodiment of the present invention. Referring to FIG. 2, a funding profile is validated and executed with no constraints 202. This unconstrained run represents the system's requirements. The BRMG assumes meeting this requirement achieves 100% system readiness.

For each year, funding elements that have a zero requirement or are not executed in that year are filtered out 208 and not considered within the list of tasks to be optimized. If in multi-year mode 212, any carryovers from a previous year's unfunded requirements are added 216.

For each dataset in each year of the model run, an available funding value is entered 220. In one embodiment of the present invention, the available funding value is entered as direct dollar amounts. However, the invention is not so limited. By way of illustration and not as a limitation, the available funding value may be entered as budgeted dollar amounts or percentages of total funding.

In the exemplary embodiment, a “Cost Constraint Optimization” is performed 224 using a steadily declining “available funding” value. All funding elements (FEs) are sorted by priority, with funding elements for which funding is mandatory set to priority=0. A cumulative sum is included in the priority list. Table 1 reflects data that is representative of the operation of the BRMG to this stage for this system:

TABLE 1

| | | Partial | | | | |
|---|---|---|---|---|---|---|
| FE# | FE Code | funding | Priority | Cost | Ri | Sum |
| 1 | 3.3.a | 100% | 0 | $10 | 0.1 | $10 |
| 2 | 3.3.b | 10% | 1 | $15 | 0.2 | $25 |
| 3 | 4.5.1.b | 10% | 1 | $20 | 0.3 | $45 |
| 4 | 4.5.1.a | 10% | 2 | $16 | 0.15 | $61 |
| 5 | 6.1.a | 10% | 2 | $25 | 0.05 | $86 |
| 6 | 4.2.10.a | 10% | 5 | $40 | 0.01 | $126 |
| 7 | 3.3.1.a | 10% | 6 | $5 | 0.2 | $131 |
| 8 | 3.2.7.a | 10% | 6 | $8 | 0.15 | $139 |

Table 1 associates an FE code with each funding element. Table 1 further associates the FE code with a partial funding factor, a priority, a cost, a readiness impact (Ri) measure, and a cumulative sum of costs. According to an embodiment of the present invention, the FE code comprises a numerical component that identifies a task and letter identifier that identifies a funding category. For example FEs 1 and 2 are associated with task 3.3. FE 1 is associated with funding category “a” and FE 2 is associated with funding category (b). This identification architecture facilitates the analysis of budgetary allocations for tasks down to the funding category level.

The architecture of table 1 further facilitates the organization of systems into tasks and funding elements. As previously noted, in an embodiment of the presenting invention, funding elements compete with other funding elements of the same priority. The decision of what tasks to include within a project is, in part, determined by how the organization in charge of the system subject to the budgetary process views the tasks as competitors for resources. The BMRG may be applied to different system definitions to provide decision makers a clear view of how system and task definition reflects readiness relative to the organization's objectives.

In yet another embodiment of the present invention, the numerical component is indicative of the order in which a funding element was added to a task. Additionally, a funding element can be identified for partial funding. If the funding element is not identified for partial funding, it must be fully funded or not funded at all. If a funding element can be partially funded, a partial funding factor is associated with the funding element. The partial funding factor is applied to the cost to determine a minimum viable funding needed to perform the task.

The priority is a number from 1-10, 1 being the highest and 10 being the lowest, that sets the priority of an element within a task.

The readiness impact (Ri) measure is established for each FE. The Ri indicates the in readiness from a value of 1.0 caused by not doing a task if the task is needed. For example, if a funding element was completely unfunded with a readiness impact of 0.3, the funding element readiness equals 1-0.3 or 0.7. If the readiness impact is 0.0003, the readiness is 0.9997. If the readiness impact is 0, there is no impact, so the readiness is 1.0. If the funding element is funded at 100%, its readiness is 1.0. If it is partially funded its readiness impact is the product of the unfunded percentage and the Ri. For example, if a funding element with a readiness impact of 0.2 was funded at 50%, its readiness impact would be 0.2*0.5 or 0.1. Its readiness would be 1-0.1 or 0.9.

The “Sum” column provides a cumulative sum of all FEs assuming they are fully funded. As illustrated in Table 1, the funding required for the FEs 1-8 is $139.

The available funding is then used to determine a “priority constraint point” 228, or the priority at which the first cuts will occur. The priority constraint point is used to parse the list into three parts 232:
a. FEs above the priority constraint point
b. FEs below the priority constraint point
c. FEs at the priority constraint point.

For example, if the cost constraint is 63 dollars, the priority constraint point would be priority=2, and the above FE list would be parsed as illustrated in Table 2:

TABLE 2

| | WBS | Partial | | | | | |
|---|---|---|---|---|---|---|---|
| FE# | Code | funding | Priority | Cost | Ri | Sum | Funding |
| 1 | 3.3.a | 100% | 0 | $10 | 0.1 | $10 | $10 |
| 2 | 3.3.b | 10% | 1 | $15 | 0.2 | $25 | $15 |
| 3 | 4.5.1.b | 10% | 1 | $20 | 0.3 | $45 | $20 |
| 4 | 4.5.1.a | 10% | 2 | $16 | 0.15 | $61 | $16 |
| 5 | 6.1.a | 10% | 2 | $25 | 0.05 | $86 | |
| 6 | 4.2.10.a | 10% | 5 | $40 | 0.01 | $126 | |
| 7 | 3.3.1.a | 10% | 6 | $5 | 0.2 | $131 | $2 |
| 8 | 3.2.7.a | 10% | 6 | $8 | 0.15 | $139 | |

According to an embodiment of the present invention, the FEs above the priority constraint point are automatically funded 236. A determination is made as to whether funds remain 238. If no funds remain, the process ends 250. If funds remain, the remaining dollars are used to optimize the FEs at the priority constraint point 240. In the above example, the BRMG would seek to maximize the readiness with FEs 4-5 constrained by 63−45=$18.

A determination is made as to whether funds remain 242. If no funds remain, the process ends 250. If funds remain, the FEs “below” the priority constraint point are funded 244. A determination is made as to whether funds remain 242, the process continues as previously described. In the example illustrated in Table 2, after funding of FE 4, $2 remain. However, the partial funding factor for FE 5 is 10% and the partial funding minimum is 10% of $25 or $2.50. For FE 6, the partial funding factor is 10% and the partial funding minimum is 10% of $40 or $4. The $2 that remains cannot, therefore, be allocated to either FE 5 or 6. However, the partial funding minimum of FE 7 is 10% of $5, or $0.50 and the partial funding of FE 7 is 10% of $8 or $0.80. As FE 7 and 8 are of equal priority, the allocation of the remaining funds is determined by reference to the Ri factor. The Ri factor of FE 7 is 0.2 while the Ri factor of FE 8 is 0.15. Because FE 7 has a greater impact on the overall readiness of the task, the the remaining $2 is allocated to FE 7, leaving it unfunded by 60%.

The BRMG repeats this process until all dollars are spent or there are no lower priority FEs to optimize. If the BRMG runs out of money before reaching the end of the priority list, all remaining FEs are automatically unfunded.

In an embodiment of the present invention, the readiness for the entire budget is calculated using the principle of probability of independent events where the probability that multiple events occur is the product of their independent probabilities. In the event a funding element is partially funded, its readiness impact is then multiplied by the percentage the funding element is not funded. To determine the budget readiness, the readiness of each funding element is calculated as defined in the proceeding paragraph. The readiness value for each independent funding element is multiplied together. Funding elements funded at 100% are equal to 1.0 and do not effect the budget readiness. Therefore, only funding elements that were partially funded and unfunded need be investigated. Using the above example, the following table illustrates the information needed to calculate the total budget readiness.

TABLE 3

| FE | Ri | UnFunded % | Readiness Impact | FE Readiness |
|---|---|---|---|---|
| 5 | 0.05 | 100 | 0.05 | 0.95 |
| 6 | 0.01 | 100 | 0.01 | 0.99 |
| 7 | 0.2 | 60 | 0.12 | 0.88 |
| 8 | 0.15 | 100 | 0.15 | 0.85 |

The probability of these independent funding readiness values would be: 0.703494.

In the event there are multiple funding categories, the partially and unfunded funding elements are segregated by funding category to determine the funding category readiness. The total budget readiness becomes the weighted average of the fund category readiness where each funding category is assigned a readiness allocation between 0 and 1 where all funding category readiness allocations sum to 1. This allows a decision maker to assign a larger or smaller portion of importance to funding categories within the budget as a whole.

Table 4 illustrates an example using the above example with funding categories A and B with readiness allocations of 30% and 70% respectively:

TABLE 4

| | | | Readiness | | Fund |
|---|---|---|---|---|---|
| FE | Ri | UnFunded % | Impact | FE Readiness | Category |
| 5 | 0.05 | 100 | 0.05 | 0.95 | A |
| 6 | 0.01 | 100 | 0.01 | 0.99 | B |
| 7 | 0.2 | 60 | 0.12 | 0.88 | B |
| 8 | 0.15 | 100 | 0.15 | 0.85 | A |

Funding Category A Readiness=0.95*0.85=0.8075. Funding Category B Readiness=0.99*0.88=0.8712. The total Budget Readiness would be 0.8075*30%+0.8712 * 70%=0.85209.

In an alternate embodiment, the BRMG is applied to determine an optimal allocation of resources if the constraint is readiness rather than funding. This analysis starts with a determination of an acceptable lower readiness level. The BRMG determines the funding required to produce that reduced readiness. The readiness-constrained model run behaves in much the same way as cost constrained model run.

In an embodiment of the present invention, a readiness run is executed as a cost constrained run where the cost to achieve a targeted readiness is found by methodically searching for the closest cost corresponding to the desired readiness using a Phi (Φ) or “Golden” search. The constant used in the search is Φ−1≈0.618. The percentages of the executable funding range (from the total must fund amount to the total funding) are searched by products of (Φ−1) in order to find the readiness target.

In this embodiment, the BRMG executes a cost constrained run with the “runner” as the funding constraint. The first runner, regardless of the readiness target, equals the product of the requirements funding (minus funds associated with funding elements for which funding is mandatory ) and (Φ−1). Upon completion, the BRMG calculates the resulting readiness. If the readiness result is less than the target readiness, the funding is increased. If the readiness result is greater than the target, funding is reduced. The BRMG will search until either the readiness result is within a specified variance (1%, for example) or the upper and lower search bounds are within a certain variance (0.5%, for example). That is, the process will terminate when it is reasonably close to the readiness target or until there is no substantial search zone left.

Implicit in this search is the assumption that more funding means more readiness. While this is true on the larger level, there exists the possibility that more local searches won't follow this rule. Consider that if the last priority 3 task (Table 2) to be funded has a very small readiness impact, but the first priority 4 task (Table 2) to be funded has a very large impact, the loss of funding that triggers the priority 3 task (Table 2) to be unfunded and the priority 4 task (Table 2) to be funded will actually increase the readiness result. To minimize the effects of this phenomenon, the BRMG keeps track of the best answer. When the search is exhausted without getting close enough to the target readiness, the BRMG compares the current result with the best answer previously achieved. If the current answer is not better than the previously recorded value, the BRMG will re-run the optimization with the “best answer” and terminates the search. While not a perfect solution, it this approach does help to minimize the effects.

In an exemplary embodiment of the present invention the BRMG is implemented to determine what the budgeting requirements are for a Federal Government organization such as the Federal Emergency Management Agency (FEMA). Within FEMA there are a number of Divisions (referred to as Programs in FIG. 1) including Preparedness, Recovery, and Response to name a few. Within the Preparedness Division there are a number of programs (referred to as systems in FIG. 1) including Community and Family Preparedness, Community Emergency Response Teams, and Fire Safety Campaigns for example. For purposes of illustration and not as limitation, a BRMG is applied to budgetary information for Fire Safety Campaigns. In order to use the BRMG and develop a funding profile, a user would define the mission for Fire Safety Campaign and then the funding categories that support that mission, such as Public Education and State and Local Training. Public Education is then defined by mission and requirements to determine the supporting tasks. These tasks could include educating businesses and educating families with supporting funding elements that would include research of materials, development of materials, printing materials, distribution, radio/TV campaigns, etc. These tasks and funding elements are prioritized and weighted with an impact to the goal of successfully educating the public on fire safety. The BRMG would be initially run to determine the total budgeting requirements to meet the Fire Safety Campaigns mission. A constrained run would then be conducted based on the funding allotted to this program to determine the resultant effectiveness of the program to meet its defined mission (readiness). The BRMG would fund the highest priority funding elements first and continue through the priorities until funding was exhausted. At that point per the example in Table 1 and detailed previously, the BRMG would fund funding elements based on readiness impact or partial funding to get the most effectives from the remaining funds.

While the preceding example describes an embodiment of the present invention directed to a budgetary process of a federal agency, as will be appreciated by those skilled in the art, the present invention is not so limited. In another embodiment of the present invention, the BRMG receives data from all federal agencies within a department to produce an aggregated budgetary model for that department. In still another embodiment of the present invention, the budgetary models of all federal departments are aggregated to produce a unified budgetary model for the federal government.

In yet another embodiment of the present invention, the BRMG receives financial data from agencies and departments comprising a state or local government.

In another embodiment of the present invention, the BRMG receives financial data from a budgetary unit of a business entity to produce a budgetary model for providing goods and services on a commercial basis. In still another embodiment of the present invention, the BRMG receives data from all of the budgetary units of the business entity to produce an aggregated budgetary model for that entity.

In even another embodiment of the present invention, the BRMG receives financial data from a budgetary unit of a charitable organization entity to produce a budgetary model for distributing donated goods and services. In still another embodiment of the present invention, the BRMG receives data from all of the budgetary units of the charitable organization to produce an aggregated budgetary model for that entity.

A budgeting requirements model generator has been described. It will be understood by those skilled in the art that the present invention may be embodied in other specific forms without departing from the scope of the invention disclosed and that the examples and embodiments described herein are in all respects illustrative and not restrictive. Those skilled in the art of the present invention will recognize that other embodiments using the concepts described herein are also possible. Further, any reference to claim elements in the singular, for example, using the articles “a,” “an,” or “the” is not to be construed as limiting the element to the singular. Moreover, a reference to a specific time, time interval, and instantiation of scripts or code segments is in all respects illustrative and not limiting.

What is claimed is:

1. A method for generating a budgetary model comprising:
establishing an available funding for a project, wherein the project comprises funding elements, and wherein each funding element is associated with a priority, a cost of completing the funding element, an FE readiness measure, and a partial funding minimum;
ordering the funding elements according to a descending priority;
determining whether a remaining funding for the project is equal to or greater than the cost of completing a particular funding element, wherein the remaining funding is the available funding less amounts allocated for other funding elements;
if the remaining funding for the project is equal to or greater than the cost of completing the particular funding element, then:
allocating a portion of the remaining funding to the funding element equal to the cost of completing the funding;
if the remaining funding for the project is less than the cost of completing the particular funding element, then:
determining whether a particular FE readiness measure of the particular funding element is greater than other FE readiness measures of the other funding elements having the same priority as the particular FE readiness measure;
determining whether the remaining funding for the project exceeds the partial funding minimum of the particular funding element; and
allocating the remaining funding for the project to the particular funding element if the particular FE readiness measure of the particular funding element is greater than the FE readiness measures of the other funding elements having the same priority as the particular funding element and if the remaining funding exceeds the partial funding minimum of the particular funding element.

2. The method of claim 1, wherein if the remaining funding for the project is less than the cost of completing the particular funding element the method further comprising:
determining whether the remaining funding for the project exceeds the partial funding minimum of a next funding element having the same priority as the particular funding element;
determining whether a FE readiness measure of the next funding element is greater than readiness measures the other next funding elements having the same priority as the particular funding element; and
allocating the remaining funding to the next funding element having the same priority as the particular funding element if the FE readiness measure of the next funding element is greater than the FE readiness measures of the other next funding elements having the same priority as the particular funding element and if the remaining funding exceeds the partial funding minimum of the next funding element.

3. The method of claim 2, wherein if the remaining funding for the project exceeds the partial funding minimum of the next funding element having the same priority as the particular funding element, the method further comprises:
determining whether the remaining funding for the project exceeds the partial funding minimum of a later funding element having a lower priority than the particular funding element;
determining whether a FE readiness measure of the later funding element is greater than readiness measures of other later funding elements having the same lower priority as the later funding element; and
allocating the remaining funding to the later funding element having lower priority than the particular funding element if the FE readiness measure of the later funding element is greater than the FE readiness measures of the other later funding elements having the same lower priority as the later funding element and if the remaining funding exceeds the partial funding minimum of the later funding element.
